(19) United States
(12) Patent Application Publication
(10) Pub. No.: US 2026/0244408 A1
(43) Pub. Date: Aug. 20, 2026

(54) GENERATING CODE FOR NARROW AI DOMAINS UTILIZING TREE-BASED RESTRICTED DECODING IN LLMS

(71) Applicant: Adobe Inc., San Jose, CA (US)

(72) Inventors: Chetan Sharma, Agra (IN); Soumyabrata Pal, Bengaluru (IN); Ramasuri Narayanam, Bangalore (IN); Shiv Kumar Saini, Bengaluru (IN); Koyel Mukherjee, Bangalore (IN)

(21) Appl. No.: 19/053,824

(22) Filed: Feb. 14, 2025

(51) Int. Cl. G06F 8/30; G06F 16/21; G06F 40/284

(52) U.S. Cl. CPC G06F 8/30; G06F 16/211; G06F 40/284

(57) ABSTRACT

The present disclosure relates to systems, non-transitory computer-readable media, and methods for utilizing token tree-based restricted decoding in large language models to generate code for narrow AI domains. In particular, the disclosed systems determine a database schema of a database in response to a natural language prompt for a large language model to generate code for performing an operation on the database. Additionally, the disclosed systems restrict a decoding space of the large language model to tokens of a token tree representing elements of the database schema according to a tokenizer of the large language model. Further, the disclosed systems generate, utilizing the large language model, one or more portions of the code by traversing the tokens of the token tree according to token edges of the token tree and a decoded token sequence.

### BACKGROUND

Recent years have seen significant improvements in systems for utilizing large language models to generate responses to natural language prompts. For example, some systems attempt to perform highly structured tasks such as generating programming code using large language models based on natural language prompts. Due to the syntactic constraints and requirements of these highly structured tasks to ensure accurate functionality of the programming code or other generated content, minimizing errors common to large language models (e.g., hallucination) is a challenging task. Specifically, hallucinations in large language model results for programming code often introduce syntactic errors, execution errors, or incorrect device/database calls (e.g., via hallucinated table names or column names) Various attempts by existing systems to satisfy the syntactic constraints of highly structured tasks include in-context learning, fine-tuning of large language models, and grammar-constrained decoding.

Although some conventional systems generate programming code using large language models, such systems have a number of problems in relation to efficiency and accuracy. For instance, conventional systems that perform highly structured tasks using large language models inefficiently generate structured content relative to standard auto-regressive generation methods. For example, such conventional systems increase the inference time required, at least in part, by incorporating methods aimed at minimizing errors such as hallucination. To illustrate, conventional systems that utilize grammar-constrained decoding must translate the natural language prompt into code in real time and attempt to restrict the output space based on the previously generated tokens given a set of globally valid structural constraints. While such methods may result in fewer hallucination errors relative to other conventional systems, these methods also increase the inference time.

In addition, some conventional systems often inaccurately generate programming code. Specifically, these conventional systems hallucinate when generating code resulting in syntactically invalid code and or code with low execution accuracy. Even conventional systems that incorporate improved methods for generating programming code such as grammar-constrained decoding often generate code with semantic errors such as by using schema items in the programming language incorrectly. Again, these semantic errors result in syntactically or functionally invalid code. Thus, existing systems typically have tradeoffs between accuracy and efficiency such that more accurate systems suffer significantly from latency issues, while more efficient systems suffer significantly from accuracy and hallucination issues.

### SUMMARY

Embodiments of the present disclosure provide benefits and/or solve one or more of the foregoing or other problems in the art with systems, non-transitory computer-readable media, and methods for utilizing token tree-based restricted decoding in large language models to generate code for narrow AI domains. In particular, the disclosed systems leverage the structure of the narrow AI domain by generating token trees based on the database schema elements of the AI domain database. In some embodiments, the disclosed systems also generate a token tree based on the elements of the programming language of the generated code. Further, in some implementations, the disclosed systems restrict a decoding space of the large language model utilizing the token trees (e.g., corresponding to the programming language and the database schema) when generating the code with the large language model. Moreover, in one or more embodiments, the disclosed systems utilize the generated code to perform an operation on the database for returning results responsive to a natural language prompt on a client device. The disclosed systems thus improve accuracy of large language models by reducing hallucinations while also improving latency of the large language models.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a tree guided decoding system operates in accordance with one or more embodiments.

FIG. 2 illustrates an overview diagram of the tree guided decoding system utilizing a large language model with a restricted decoding space to generate code for performing an operation on a database in accordance with one or more embodiments.

FIG. 3 illustrates a diagram of the tree guided decoding system restricting the decoding space of a large language model to generate code in accordance with one or more embodiments.

FIG. 4 illustrates a diagram of the tree guided decoding system generating token trees in accordance with one or more embodiments.

FIG. 5 illustrates a diagram of the tree guided decoding system generating a decoded token sequence by restricting the decoding space of the large language model to a language token tree in accordance with one or more embodiments.

FIG. 6 illustrates a diagram of the tree guided decoding system generating a decoded token sequence by restricting the decoding space of a large language model to a column token tree in accordance with one or more embodiments.

FIG. 7 illustrates a diagram of the tree guided decoding system generating a decoded token sequence by restricting the decoding space of a large language model to a table token tree in accordance with one or more embodiments.

FIG. 8 illustrates an example schematic diagram of the tree guided decoding system in accordance with one or more embodiments.

FIG. 9 illustrates a flowchart of an example series of acts for utilizing token tree-based restricted decoding in large language models to generate code for narrow AI domains in accordance with one or more embodiments.

FIG. 10 illustrates a block diagram of an example computing device for implementing one or more embodiments of the present disclosure.

### DETAILED DESCRIPTION

This disclosure describes one or more embodiments of a tree guided decoding system that utilizes token tree-based restricted decoding in large language models to generate code for narrow AI domains. For example, the tree guided decoding system generates token trees based on the database schema elements of a database. Furthermore, in one or more implementations, the tree guided decoding system generates a token tree based on the elements of the programming language of the code to be generated. Additionally, in some embodiments, the tree guided decoding system restricts a decoding space of the large language model utilizing the token trees when generating the code with the large language model. Further, in some implementations, the tree guided decoding system utilizes the generated code to perform an operation on the database for returning results responsive to a natural language prompt on a client device.

As mentioned above, in one or more embodiments, tree guided decoding system generates token trees based on database schema elements of a database. In particular, the tree guided decoding system generates a table token tree based on table names of tables of the database schema. Moreover, in one or more implementations, the tree guided decoding system generates a column token tree based on column names in the tables in the database schema. Furthermore, in some embodiments, the tree guided decoding system generates the table token tree and the column token tree by utilizing a tokenizer of the large language model to generate tokens from the table and column names. Additionally, in some implementations, the tree guided decoding system generates the token trees indicating relationships of the generated tokens.

As noted above, in one or more embodiments, the tree guided decoding system generates a language token tree based on elements of a programming language of the code to be generated. Specifically, similar to generating the tokens for the elements of the table token tree and the column token tree, the guided decoding system utilizes the tokenizer of the large language model to generate tokens based on the elements (e.g., keywords) of the programming language. Additionally, the tree guided decoding system generates the language token tree indicating relationships of the tokens representing programming language elements.

As mentioned previously, in one or more implementations, the tree guided decoding system restricts a decoding space of the large language model utilizing the token trees when generating the code via the large language model. In particular, the tree guided decoding system utilizes a large language model to generate the code for performing an operation on the database. Based on one or more decoded tokens of a decoded token sequence, in some embodiments, the tree guided decoding system restricts the decoding space of the large language model from a default decoding space of the large language model to the tokens of a token tree. In these or other embodiments, the tree guided decoding system utilizes the large language model to generate a next token in the decoded token sequence from the restricted decoding space (i.e., from the tokens of the token tree.

As noted previously, in some implementations, the tree guided decoding system utilizes the generated code to perform an operation on the database for displaying results responsive to a natural language prompt on a client device. Specifically, in response to the natural language prompt, the tree guided decoding system generates the code utilizing the large language model with the restricted decoding space. Further, in one or more embodiments, the tree guided decoding system accesses the database and executes the generated code to perform one or more operations on the database, thereby generating results responsive to the natural language prompt. Moreover, in one or more implementations, the tree guided decoding system displays the results on a client device (e.g., the client device that submitted the natural language prompt).

Furthermore, embodiments of the tree guided decoding system provide a variety of improvements relative to conventional systems. For example, by restricting the decoding space of a large language model to tokens of one or more token trees and auto-filling relevant tokens of a decoded token sequence based on the token tree(s), the tree guided decoding system improves efficiency relative to conventional systems. In particular, the tree guided decoding system improves efficiency over conventional systems by incorporating the speculative decoding-like capability of auto-filling. Indeed, as described in further detail below, the tree guided decoding system generates multiple tokens of the decoded token sequence in a single time step by auto-filling tokens during inference. For example, the tree guided decoding system auto-fills tokens of the decoded token sequence by traversing the tokens of the token tree according to the token edges of the token tree within a restricted decoding space of a large language model. Thus, the tree guided decoding system reduces the latency of generating a response relative to conventional systems that employ auto-regressive decoding techniques (e.g., conventional systems that perform highly structured tasks) by auto-filling multiple tokens at single time steps when generating code.

Additionally, by restricting the decoding space of a large language model and decoding tokens based on the tokens of the restricted decoding space, the tree guided decoding system improves accuracy relative to conventional systems. Specifically, the tree guided decoding system improves accuracy by reducing hallucination of large language models relative to conventional systems. For example, the tree guided decoding system generates token trees that accurately incorporate the elements of database schemas and programming languages. Further, the tree guided decoding system utilizes these trees to accurately determine when (e.g., at which time steps of inference of the large language model) to restrict the decoding space of the large language model to the tokens of a token tree. Moreover, the tree guided decoding system decodes tokens of a decoded token sequence (e.g., representing code being generated by the large language model) using only tokens that are actually included in the database schema and/or programming language. Further, the tree guided decoding system improves the accuracy while simultaneously improving the efficiency using the token trees as just described, an extremely difficult task that many conventional systems cannot achieve.

As illustrated by the foregoing discussion, the present disclosure utilizes a variety of terms to describe features and advantages of the tree guided decoding system. Additional detail is now provided regarding the meaning of such terms. For example, as used herein, the term “database schema” refers to a logical structure of a database. In particular, a database schema includes a logical structure that defines how data is organized, stored, and related within a system. To illustrate, in some embodiments, a database schema includes tables where data is stored in rows and columns. For instance, each table of the database schema includes columns defining the types of data stored such as specific integers, strings, dates, etc., related to specific concepts. As an example, a table in the database schema includes data related to one or more segments for customer data with columns defining different values related to the stored data.

Relatedly, an “element,” as used herein, refers to alphanumeric and/or other characters representing components of a programming language or a database schema. For example, an element of a programming language includes a programming language keyword. Indeed, this disclosure uses “element” and “keyword” interchangeably when referring to an element of a programming language. To further illustrate, an element of a database schema includes a table name or a column name of the database schema.

Moreover, in some implementations, the term “token tree,” as used herein, refers to a hierarchical data graph consisting of vertices and edges. In particular, a token tree includes tokens (e.g., generated utilizing a tokenizer of a large language model) as vertices. Furthermore, in one or more embodiments, the edges (also referred to herein as token edges) of a token tree represent and preserve connections between tokens (or vertices of the token tree) to reflect the order of elements (and/or sub-elements) prior to tokenization. In one or more implementations, token trees include various different types of token trees such as a language token tree comprising tokens based on elements of a programming language, a table token tree comprising tokens based on table names of a database schema, or a column token tree comprising tokens based on column names of a database schema.

Additionally, as used herein, the term “decoding space” refers to a range of all possible outputs that a model, such as a large language model is capable of generating in response to a given input. In particular, a decoding space includes the set of token sequences the model can produce, shaped by its vocabulary, learned probabilities, and/or the context provided in the input. Furthermore, the term “restricted decoding space” refers to a decoding space restricted to a particular subset of tokens less than a default/initial decoding space of a large language model. For example, the tree guided decoding system restricts the decoding space to a particular subset of tokens, such as tokens of a token tree.

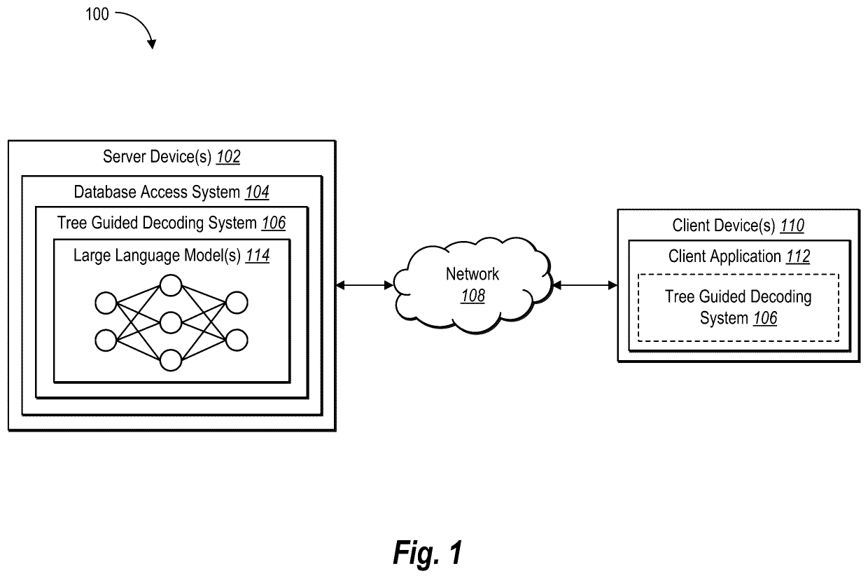

Additional detail regarding the tree guided decoding system 106 will now be provided with reference to the figures. For example, FIG. 1 illustrates a schematic diagram of a system environment 100 in which a tree guided decoding system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the tree guided decoding system 106 via the network 108). Similarly, although FIG. 1 illustrates a particular arrangement of the server device(s) 102, the network 108, and the client device(s) 110, various additional arrangements are possible.

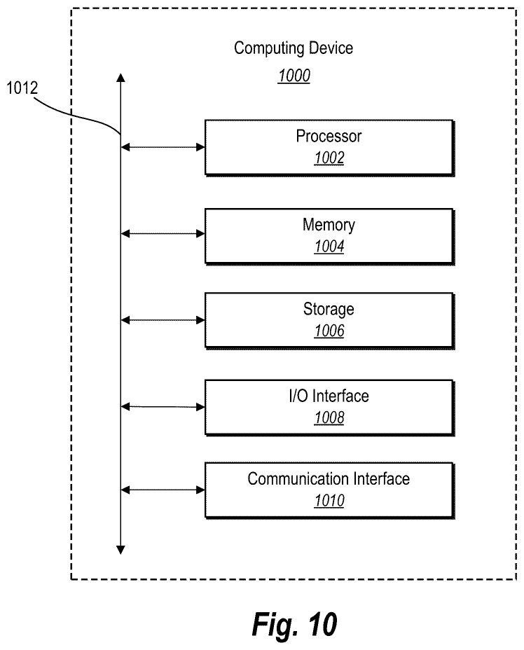

The server device(s) 102, the network 108, and the client device(s) 110 are communicatively coupled with each other either directly or indirectly (e.g., through the network 108 discussed in greater detail below in relation to FIG. 10). Moreover, the server device(s) 102 and the client device(s) 110 include one or more of a variety of computing devices (including one or more computing devices as discussed in greater detail with relation to FIG. 10).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a database access system 104. In one or more embodiments, the database access system 104 provides functionality by which a client device (e.g., the client device(s) 110) views, generates, stores, and/or edits a database and/or database content. For example, in some instances, a client device sends a natural language prompt to the database access system 104 hosted on the server device(s) 102 via the network 108. The database access system 104 then provides a response (e.g., a natural language response) or performs an operation in response to the natural language prompt. To illustrate, the database access system 104 provides a response to the natural language prompt or performs the operation requested in the natural language prompt on the database.

As further shown, the server device(s) 102 also include the tree guided decoding system 106 generating content such as code utilizing one or more large language models to be performed by the database access system 104. In one or more embodiments, the tree guided decoding system 106 generates the code by restricting the decoding space of the large language model(s) and generating tokens of the code from the tokens of the token tree. Specifically, the tree guided decoding system 106 generates one or more token trees including tokens representing elements of a database schema of the database and/or elements of a programming language of the database schema for use in restricting the decoding space of the large language model(s). Further, as will be explained below, the tree guided decoding system 106 restricts the decoding space of the large language model(s) based on tokens of a decoded token sequence (of the code being decoded). Moreover, the tree guided decoding system 106 generates the tokens of the decoded token sequence by traversing the tokens of the token tree according to token edges of the token tree.

As illustrated in FIG. 1, the tree guided decoding system 106 includes large language model(s) 114. Indeed, in these or other embodiments, the tree guided decoding system 106 accesses the large language model(s) 114 to restrict the decoding space thereof and/or generate outputs such as code executable on a database. In some cases, the large language model(s) 114 are external to the tree guided decoding system 106, but the tree guided decoding system 106 nevertheless accesses and utilizes the large language model(s) 114 via one or more plugins, APIs, or other network-based access protocols.

In some embodiments, a large language model includes or refers to a specialized type of machine learning model, and more particularly, a specialized type of neural network. For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks or decision tree models.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more implementations, the large language model(s) 114 includes an artificial intelligence model capable of processing and generating natural language text or other language-based prompts using language understanding. In particular, large language models are trained on large amounts of data to learn patterns and rules of language. As such, a large language model post-training is capable of generating output predictions such as predicted text (e.g., left-to-right predicted text). Further, in some embodiments, a large language model includes or refers to one or more decoder-only large language models capable of processing language-based prompts (e.g., natural language text) to generate outputs such as code. In particular, a large language model includes parameters trained (e.g., via deep learning) on large amounts of data to learn patterns and rules of language for summarizing and/or generating text.

In one or more embodiments, the client device(s) 110 includes a computing device that accesses, edits, segments, modifies, stores, and/or provides, for display, digital content such as digital documents with artificial intelligence generated content. For example, in some embodiments, the client device(s) 110 includes a smartphone, a tablet, a desktop computer, a laptop computer, a head-mounted-display device, or another electronic device, including those explained below with reference to FIG. 10. In some instances, the client device(s) 110 includes one or more applications (e.g., a client application 112) that access, edit, segment, modify, store, and/or provide, for display, digital content such as digital documents with artificial intelligence generated content. For example, in one or more embodiments, the client application 112 includes a software application installed on the client device(s) 110. Additionally, or alternatively, the client application 112 includes a web browser or other application that accesses a software application hosted on the server device(s) 102 (and supported by the database access system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicate via the network using one or more communication platforms and technologies suitable for transporting data and/or communication signals, including any known communication technologies, devices, media, and protocols supportive of data communications, examples of which are described with reference to FIG. 10.

To provide an example implementation, in some embodiments, the tree guided decoding system 106 on the server device(s) 102 supports the tree guided decoding system 106 on the client device(s) 110. For instance, in some cases, the tree guided decoding system 106 on the server device(s) 102, via the server device(s) 102, provides the large language model(s) 114 to the client device(s) 110. In other words, the client device(s) 110 obtains (e.g., downloads) the large language model(s) 114 from the server device(s) 102. Once downloaded, the tree guided decoding system 106 on the client device(s) 110 uses the large language model(s) 114 to generate and implement outputs such as code independent of the server device(s) 102. In some implementations, the tree guided decoding system 106 generates or learns parameters for the large language model(s) 114 on the client device(s) 110.

In alternative implementations, the tree guided decoding system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as token trees including tokens representing elements of a database schema and/or programming language for use as a restricted decoding space of a large language model. In response, the tree guided decoding system 106 on the server device(s) 102 generates code using the large language model with the restricted decoding space. The server device(s) 102 then provides the code or a response to a natural language prompt used to generate the code to the client device(s) 110 for display and/or further processing.

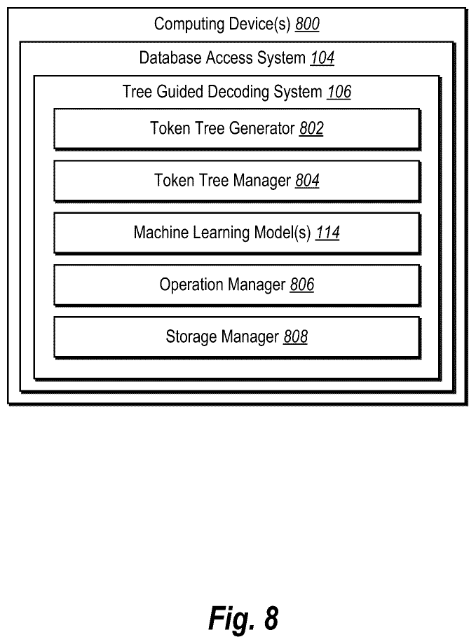

Although FIG. 1 illustrates the tree guided decoding system 106 implemented with regard to the server device(s) 102, different components of the tree guided decoding system 106 are able to be implemented by a variety of devices within the system environment 100. For example, in some instances, a different computing device (e.g., the client device(s) 110) or a separate server from the server device(s) 102 implements one or more (or all) components of the tree guided decoding system 106. Indeed, as shown in FIG. 1, the client device(s) 110 includes the tree guided decoding system 106. Example components of the tree guided decoding system 106 will be described below with regard to FIG. 8.

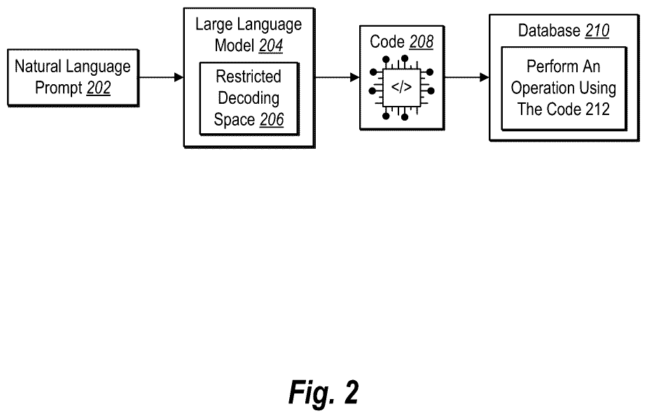

As previously mentioned, in some implementations, the tree guided decoding system 106 utilizes token tree-based restricted decoding in large language models to generate code for performing an operation on a database. For example, the tree guided decoding system 106 generates the code in response to a natural language prompt requesting information (e.g., for searching a database for specific data indicated in the natural language prompt utilizing one or more SQL queries). FIG. 2 illustrates an overview diagram of the tree guided decoding system 106 utilizing a large language model with a restricted decoding space to generate code for performing an operation on a database in accordance with one or more embodiments.

As illustrated in FIG. 2, in one or more embodiments, the tree guided decoding system 106 receives and/or determines a natural language prompt 202 (e.g., from a client device) for a large language model 204 (e.g., large language model(s) 114). In particular, the tree guided decoding system 106 receives the natural language prompt 202 requesting information regarding a database. For example, the tree guided decoding system 106 determines that the natural language prompt 202 requests or requires generation of code for performing an operation on a database(s) 210 containing information related to one or more datasets (e.g., user segmentation data). In these or other embodiments, the tree guided decoding system 106 operates as part of an AI system for answering natural language queries related to various operations on the database(s) 210 and/or operations associated with a particular entity.

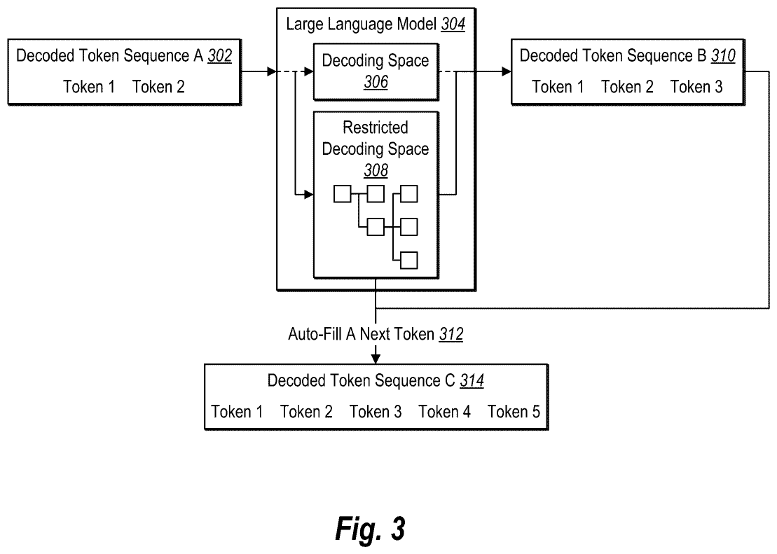

As further illustrated in FIG. 2, in one or more implementations, the tree guided decoding system 106 utilizes a large language model 204 with a restricted decoding space 206 to generate code 208 in response to the natural language prompt 202. Specifically, the tree guided decoding system 106 utilizes the large language model 204 to generate the code 208 utilizing a decoding space of the large language model 204. Furthermore, in some embodiments, the tree guided decoding system 106 restricts a default decoding space of the large language model 204 to a restricted decoding space 206. Additional detail regarding restricting the decoding space of the large language model 204 is provided with respect to FIGS. 3 and 5-7.

As additionally shown in FIG. 2, in some implementations, the tree guided decoding system 106 utilizes the code 208 to perform an operation on the database 210. In particular, the tree guided decoding system 106 accesses the database 210 and performs an act 212 of performing an operation using the code 208 generated using the large language model 204. For example, the tree guided decoding system 106 utilizes the code 208 to perform the operation on the database in response to the natural language prompt 202. Additionally, in one or more embodiments, the tree guided decoding system 106 displays a response to the natural language prompt 202 on a client device (e.g., the client device from which the tree guided decoding system 106 receives the natural language prompt 202) based on performing the operation on the database.

As previously noted, in one or more implementations, the tree guided decoding system 106 generates code for performing an operation on the database. Indeed, in some embodiments, the tree guided decoding system 106 restricts the decoding space of a large language model to one or more subsets of tokens related to a database schema and/or a programming language when generating the code. FIG. 3 illustrates a diagram of the tree guided decoding system 106 restricting the decoding space of a large language model to generate code in accordance with one or more embodiments.

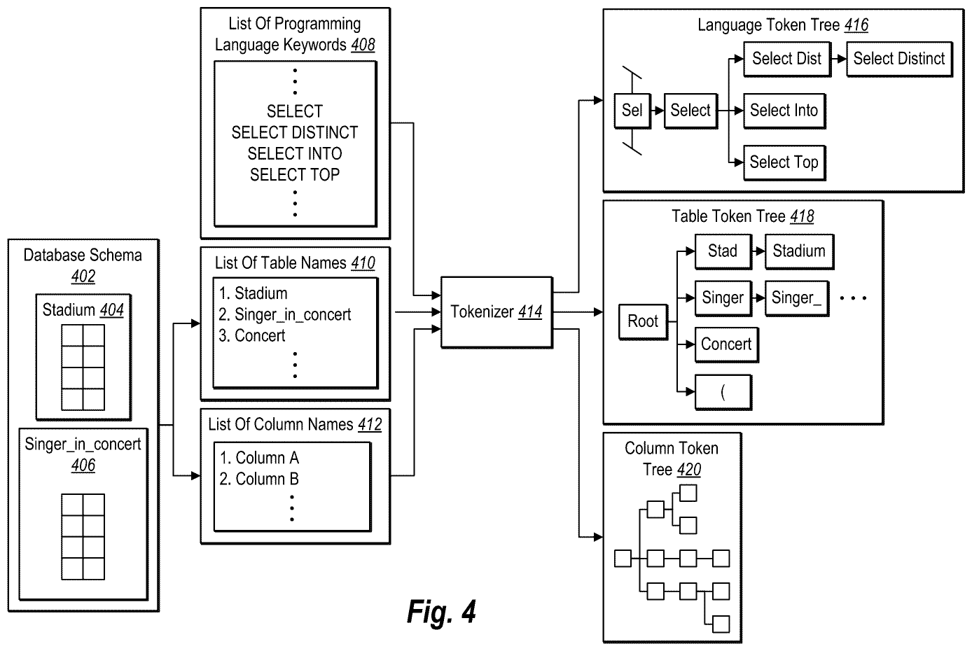

As shown in FIG. 3, in some implementations, the tree guided decoding system 106 utilizes a first decoded token sequence (i.e., decoded token sequence A 302) of code (e.g., code 208 of FIG. 2) to restrict the decoding space of the large language model 304 (e.g., large language model 204 of FIG. 2). Specifically, the tree guided decoding system 106 determines whether to restrict the decoding space of the large language model 304 based on one or more decoded tokens of the decoded token sequence A 302 generated thus far in response to a query. For example, depending on the decoded tokens (e.g., token 1 and/or token 2) of the decoded token sequence A 302, the tree guided decoding system 106 utilizes the large language model 304 with either a default decoding space (e.g., decoding space 306) or a restricted decoding space 308 (e.g., restricted decoding space 206 of FIG. 2) to decode the next token (e.g., token 3 of decoded token sequence B 310). Additional detail regarding utilizing the decoding space 306 or restricting the decoding space of the large language model to the restricted decoding space 308 is provided with respect to FIGS. 4-7.

As further illustrated in FIG. 3, in one or more embodiments, the tree guided decoding system 106 performs an act 312 of auto-filling one or more next tokens (or additional tokens) in the decoded token sequence C 314 utilizing the restricted decoding space 308. In particular, the tree guided decoding system 106 auto-fills the additional token(s) in the decoded token sequence C 314 based on decoded tokens (e.g., token 3) of the decoded token sequence B 310. For example, in some instances, the restricted decoding space 308 includes a token tree with vertices and token edges. In these or other embodiments, if the tree guided decoding system 106 determines that token 3 corresponds to a vertex with a single child in the token tree of the restricted decoding space 308, the tree guided decoding system 106 auto-fills the next token.

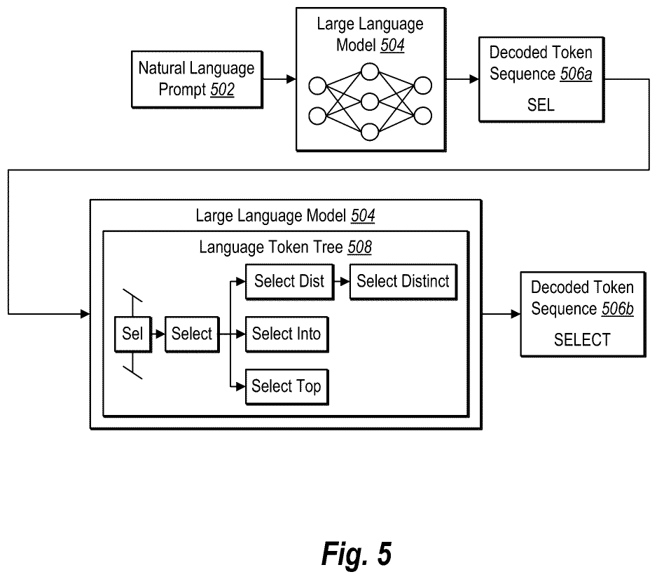

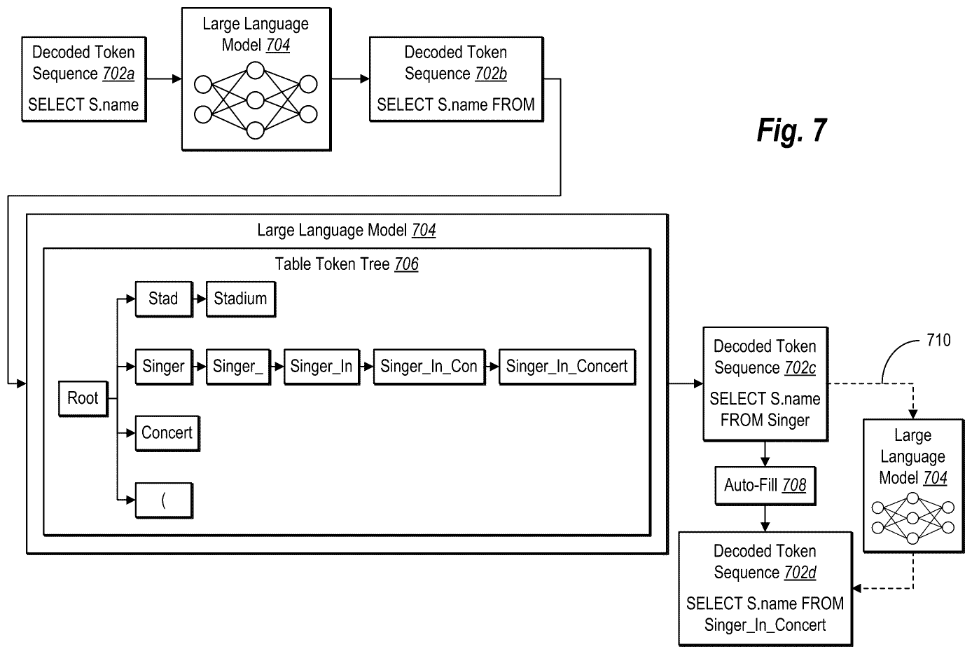

To illustrate, the tree guided decoding system 106 determines that token 3 of decoded token sequence B 310 corresponds to a vertex of the token tree of the restricted decoding space 308 with a single child vertex. Accordingly, the tree guided decoding system 106 auto-fills token 4 of the decoded token sequence C 314 with the token corresponding to the single child vertex (e.g., during the same time step of the large language model 304 as token 3). Further, in one or more implementations, the tree guided decoding system 106 follows the token edges of the token tree to generate the decoded token sequence C 314 by continuing to auto-fill tokens when possible. For example, if the vertex of the token tree corresponding to token 4 also includes a single child, the tree guided decoding system 106 also auto-fills (i.e., without calling/invoking the large language model 304 to decode) the next token, token 5. Additional detail regarding generating tokens of a decoded token sequence by auto-filling the tokens based on the restricted decoding space is provided with respect to FIGS. 5 and 7.

As mentioned above, in some embodiments, the tree guided decoding system 106 generates token trees. Indeed, in some implementations, the tree guided decoding system 106 generates token trees based on database schema elements or programming language elements. FIG. 4 illustrates a diagram of the tree guided decoding system 106 generating token trees in accordance with one or more embodiments.

As portrayed in FIG. 4, in one or more embodiments, the tree guided decoding system 106 determines a database schema 402 of a database. Specifically, the tree guided decoding system 106 determines the database schema 402 in response to a natural language prompt, such as a natural language prompt for a large language model to generate code for performing an operation on the database. Moreover, in one or more implementations, the tree guided decoding system 106 utilizes the elements of the database schema and programming language to construct token trees after generating comprehensive lists of the elements. In some embodiments, the tree guided decoding system 106 generates the token trees prior to responding to natural language queries utilizing a large language model and accesses the token trees in response to determining the relevant database schema(s) and/or programming language(s).

As also depicted in FIG. 4, in some embodiments, the tree guided decoding system 106 generates a comprehensive list of the elements of a programming language (e.g., a list of programming language keywords 408). In particular, the tree guided decoding system 106 determines the keywords of the programming language used with the database schema. For example, if the tree guided decoding system 106 determines that a particular programming language such as Structured Query Language (SQL) is used with the database schema, the tree guided decoding system 106 generates the comprehensive list of programming language keywords 408 for SQL for generating code in relation to the database schema.

As further illustrated in FIG. 4, in some implementations, the tree guided decoding system 106 generates comprehensive lists of the elements of the database schema 402. Specifically, the tree guided decoding system 106 generates a comprehensive list of table names 410 from the tables of the database schema 402. To illustrate, the database schema 402 includes a first table 404 named “stadium” and a second table 406 named “singer_in_concert.” Accordingly, the tree guided decoding system 106 generates the list of table names 410 to include the table names “Stadium,” “singer_in_concert,” and all other table names of other tables of the database schema 402.

Similarly, and as additionally shown in FIG. 4, in one or more embodiments, the tree guided decoding system 106 generates a list of column names 412 in a table (or set of tables) of the database schema 402. In particular, the tree guided decoding system 106 generates a comprehensive list of column names 412 using the names of the columns of the tables (e.g., the first table 404 and the second table 406) of the database schema 402.

Furthermore, in one or more implementations, the tree guided decoding system 106 generates the comprehensive lists (e.g., list of programming language keywords 408, the list of table names 410, and the list of column names 412) with accurate versions of the individual elements. Specifically, the tree guided decoding system 106 generates these comprehensive lists to include the various allowed versions of the elements. For example, the tree guided decoding system 106 includes accurate case (i.e., upper and lower cases) of elements or element components (e.g., letters).

To illustrate, for a column name “datasetId” in a table column, the tree guided decoding system 106 generates the correct column name, “datasetId” rather than an incorrect column name such as “DatasetId,” “datasetID,” etc. In cases where multiple versions of an element are allowed, the tree guided decoding system 106 generates the table tree with each allowed version as distinct vertices within the table tree (e.g., after tokenization as described below). In some embodiments, the tree guided decoding system 106 reduces the number of hallucinations when generating code, as described above, by generating the comprehensive lists with accurate versions of the individual elements as just described.

As further illustrated in FIG. 4, in some implementations, the tree guided decoding system 106 generates token trees utilizing tokens of the elements of the database schema and the programming language. In particular, the tree guided decoding system 106 utilizes the tokenizer 414 of the large language model to generate tokens representing the elements. For example, the tree guided decoding system 106 generates tokens representing the keywords of the programming language from the list of programming language keywords 408.

Similarly, in one or more embodiments, the tree guided decoding system 106 utilizes the tokenizer to generate tokens from the elements of the database schema. For example, the tree guided decoding system 106 generates tokens representing the names of the tables of the database schema 402 from the list of table names 410 and tokens representing the names of the columns of the database schema tables from the list of column names 412.

To illustrate mathematically, in some implementations, the tree guided decoding system 106 defines D to include the set of vocabulary corresponding to the programming language. Indeed, the tree guided decoding system 106 defines D to include the collection of programming language keywords, names of database schema tables, and names of database schema columns according to Equation (1):

$$D = \{ {a}_{1} , {a}_{2} , … {a}_{m} \} \qquad ( 1 )$$

In Equation (1), αᵢ refer to the i^{th} element of D.

In addition, in one or more embodiments, the tree guided decoding system 106 determines a set of tokens T of the decoding space of the large language model that correspond to the elements of D. according to Equation (2):

$$T = \{ ( i , j , k ) \vert {a}_{i} [ j : j + k - 1 ] ∈ V \} \qquad ( 2 )$$

In Equation (2), V refers to the vocabulary/tokens of the large language model, i refers to the i^{th} element of D (i.e., αᵢ), j refers to the starting index of substring of αᵢ, k refers to the length of that substring that corresponds to a token in V. Indeed, in these or other embodiments, T⊆V. Additionally, in one or more implementations, the tree guided decoding system 106 defines t∈Tast=(i, j, k). Further, in these or other embodiments, each token t∈T also corresponds to a token id of a tokenizer 414 of the large language model. Moreover, in some embodiments, the tree guided decoding system 106 denotes the End of Sequence token as t_{EOS}.

As noted above, the tree guided decoding system 106 generates token trees utilizing these tokens of the elements generated utilizing the tokenizer 414. Specifically, the tree guided decoding system 106 generates a language token tree 416 representing the keywords of the programming language according to the tokenizer 414 of the large language model. For example, the tree guided decoding system 106 generates vertices of the language token tree comprising the tokens representing the keywords of the programming language. Furthermore, in one or more implementations, the tree guided decoding system 106 generates the token edges of the language token tree 416 such that the token edges represent a sequence in which the tokens appear in the list of programming language keywords 408. In one or more embodiments, the sequence of tokens in the list indicates possible/valid combinations of individual tokens in generated code.

As just mentioned, the tree guided decoding system 106 generates the token edges to maintain the sequence in which the tokens appear in comprehensive list. To illustrate, the tree guided decoding system 106 maintains the sequence of the tokens according to each programming keyword using the token edges. For example, for the keywords “SELECT”, “SELECT DISTINCT”, “SELECT INTO”, and “SELECT TOP”, the tree guided decoding system 106 links each vertex token with the appropriate child vertices. Accordingly, the tree guided decoding system 106 generates a first vertex including the token “SEL” with a single child vertex “SELECT” as shown in FIG. 4.

To further illustrate, because “SELECT” is associated with at least three keywords (“SELECT DISTINCT”, “SELECT INTO”, and “SELECT TOP”), the tree guided decoding system 106 generates 3 child vertices with three distinct token edges for “SELECT.” Thus, the vertex including the token “SELECT” includes three child vertices, “DIST”, “INTO”, and “TOP.” The tree guided decoding system 106 generates the vertices and token edges of the token tree in this manner to generate the full language token tree 416 with the tokens of the list of programming language keywords 408.

Similarly, and as also depicted in FIG. 4, in some embodiments, the tree guided decoding system 106 generates a table token tree 418 and a column token tree 420 utilizing the tokens of the elements of the database schema 402 generated utilizing the tokenizer 414. In particular, the tree guided decoding system 106 generates the table token tree 418 with vertices including the tokens representing the table names and connected with token edges representing the sequence in which the tokens appear in the list of table names 410. Additionally, in some implementations, the tree guided decoding system 106 generates the column token tree 420 with vertices including the tokens representing the column names and connected with token edges representing the sequence in which the column names appear in the list of column names 412.

To illustrate mathematically, the tree guided decoding system 106 generates the token trees according to a function Next(.): T→T∪{tEOS} for each t=(i, j, k) according to Function (3):

$$Next ( t ) = \{ \begin{matrix}b = ( i , j + k , {k}^{′} ) , & b ∈ T \\ {t}_{EOS} , & Otherwise\end{matrix} \qquad ( 3 )$$

Indeed, in one or more embodiments, the tree guided decoding system 106 utilizes Function (3), to generate the tree with tokens being nodes and a set of token edges Eₜₒₖₑₙₛ. In these or other embodiments, the tree guided decoding system 106 generates the token edges according to Function (4):

$${E}_{tokens} = \{ ( t , Next ( t ) ) \vert t ∈ T \} \qquad ( 4 )$$

In one or more implementations, the token edges are defined in the decoding space of the large language model.

Further, in some embodiments, the tree guided decoding system 106 generates a mapping of the token trees to the database. Specifically, the tree guided decoding system 106 generates the mapping to the database for later access to generate the code via the large language model. For instance, the tree guided decoding system 106 accesses the token trees via the mapping to restrict the decoding space as discussed further with regard to FIGS. 5-7.

As mentioned previously, in some implementations, the tree guided decoding system 106 restricts the decoding space of the large language. For example, the tree guided decoding system 106 restricts the decoding space to generate portions of code in response to a natural language prompt. FIG. 5 illustrates a diagram of the tree guided decoding system 106 generating a decoded token sequence by restricting the decoding space of the large language model to a language token tree in accordance with one or more embodiments.

As depicted in FIG. 5, in one or more implementations, the tree guided decoding system 106 utilizes the large language model 504 (e.g., large language model 204) to generate code in response to a natural language prompt 502 (e.g., natural language prompt 202). In particular, the tree guided decoding system 106 generates a first token of a decoded token sequence 506a of the code. For example, the tree guided decoding system 106 generates the token “SEL” as the first token of the decoded token sequence 506a. In some embodiments, the tree guided decoding system 106 utilizes the underlying (or default) decoding space of the large language model 504 to generate the first token of the decoded token sequence 506a.

As further illustrated in FIG. 5, in some implementations, the tree guided decoding system 106 restricts the decoding space of the large language model 504 to generate the next token of the decoded token sequence 506b. Specifically, the tree guided decoding system 106 restricts the decoding space of the large language model 504 to the tokens of a token tree. For example, in one or more embodiments, the tree guided decoding system 106 restricts the decoding space to the tokens of a token tree based on one or more decoded tokens of the decoded token sequence.

To illustrate, in one or more implementations, the tree guided decoding system 106 restricts the decoding space of the large language model 504 to the tokens of a language token tree 508 (e.g., language token tree 416). In particular, the tree guided decoding system 106 restricts the decoding space by determining that a decoded token of the decoded token sequence 506a is present in the token tree. For example, the tree guided decoding system 106 determines that the first decoded token “SEL” of the decoded token sequence 506a is present in the language token tree 508 and restricts the decoding space to the tokens of the language token tree 508.

As additionally shown in FIG. 5, in some embodiments, the tree guided decoding system 106 utilizes the large language model 504 with the restricted decoding space to generate portions of the code. Specifically, the tree guided decoding system 106 generates a next token of the decoded token sequence 506b by traversing the tokens of the token tree. In these or other embodiments, the tree guided decoding system 106 traverses the tokens of the token tree according to the token edges of the token tree and the decoded token sequence.

To illustrate, the tree guided decoding system 106 determines a vertex of the language token tree 508 corresponding to the decoded token “SEL.” Moreover, in some implementations, the tree guided decoding system 106 determines a number of child vertices of the vertex. In these or other embodiments, the tree guided decoding system 106 generates the next token of the decoded token sequence 506b based on the number of child vertices of the vertex. In this illustration, the tree guided decoding system 106 determines the next token “SELECT” of the decoded token sequence based on the number of child vertices of the vertex. Additional detail regarding generating the next token based on the number of child vertices is provided with respect to FIG. 7.

In one or more embodiments, the tree guided decoding system 106 restricts the decoding space of the large language model to the tokens of a token tree by accessing the token tree in the database. In particular, the tree guided decoding system 106 accesses the token tree based on the mapping of the token tree to the database. Furthermore, in one or more implementations, the tree guided decoding system 106 restricts the decoding space of the large language model utilizing the token tree accessed via the mapping.

As noted previously, in some embodiments, the tree guided decoding system 106 restricts the decoding space of the large language model 504. To illustrate mathematically, in some implementations, the tree guided decoding system 106 determines (or defines) the set of outbound tokens (or substrings) given a token (or sub-string) t∈T using a function P: T→T according to Function (5):

$$P ( t ) = \{ Next ( t ) \vert ( t , Next ( t ) ) ∈ {E}_{tokens} \} \qquad ( 5 )$$

Additionally, in one or more embodiments, the tree guided decoding system 106 the tree guided decoding system 106 utilizes Function (5) to restrict the decoding space of the large language model based on another function g: T→V for each t=(i, j, k) as in Function (6):

$$g ( t ) = \{ \begin{matrix}P ( t ) , & if ∃ ( t , Next ( t ) ) ∈ {E}_{tokens} for some Next ( t ) ∈ T \\ V , & Otherwise\end{matrix} \qquad ( 6 )$$

In these or other embodiments, the tree guided decoding system 106 utilizes g(.) to perform token restriction wherever possible using Eₜₒₖₑₙₛ.

As previously mentioned, in one or more implementations, the tree guided decoding system 106 generates portions of the code by traversing the tokens of the token tree according to token edges of the token tree and a decoded token sequence. In other words, the tree guided decoding system 106 performs token tree-guided token decoding. In some embodiments, the tree guided decoding system 106 performs the token tree-guided token decoding according to Function (7):

$$h ( S , {V}^{*} ) = \{ \begin{matrix}t , & if {V}^{*} = \{ t \} \\ {f}_{LLM} ( S , {V}^{*} ) , & Otherwise\end{matrix} \qquad ( 7 )$$

In Function (7), S={t₁, t₂, . . . , tᵢ} includes the sequence of already decoded tokens wherein S[−1]=tᵢ represents the latest decoded token, f_{LLM}(S, V) represents any arbitrary large language model decoding function that auto-regressively decodes a new token from the decoding space V, and V*=g(S[−1]) denotes a decoding space (e.g., a possibly restricted decoding space) given the latest decoded token S[−1]. In these or other embodiments, if V*={t} the tree guided decoding system 106 directly auto-fills the next token (without utilizing the large language model) with h (S,V*)=t. Additional detail regarding auto-filling is provided with respect to FIG. 7.

Further, in some implementations, the tree guided decoding system 106 utilizes an algorithm to perform the token tree-guided decoding. Specifically, the tree guided decoding system 106 utilizes Algorithm 1:

Algorithm 1: Tree-guided Token Decoding for SQL Generation

| Require: S = {t₁, t₂, ..., tᵢ} Initial sequence of | |
|---|---|
| | already decoded tokens; K: Initial KV-cache; |
| | V : Vocabulary/tokens of the underlying LLM; |
| | N: Maximum length for the tokens to be generated. |
| 1: | t* = φ |
| 2: | while t* ≠ t_{EOS} or len(s) < N do |
| 3: | V* ← g(S[−1]) |
| 4: | t* ← h(S,V*) |
| 5: | S ← S ∪ t* |
| 6: | K ← ψ(t*, K) |
| 7: | end while |

In Algorithm 1, the tree guided decoding system 106 utilizes function ψ(.) to update the current state of the key-value cache of the large language model. In particular, the tree guided decoding system 106 updates the key-value cache with the calculations to decode the next token.

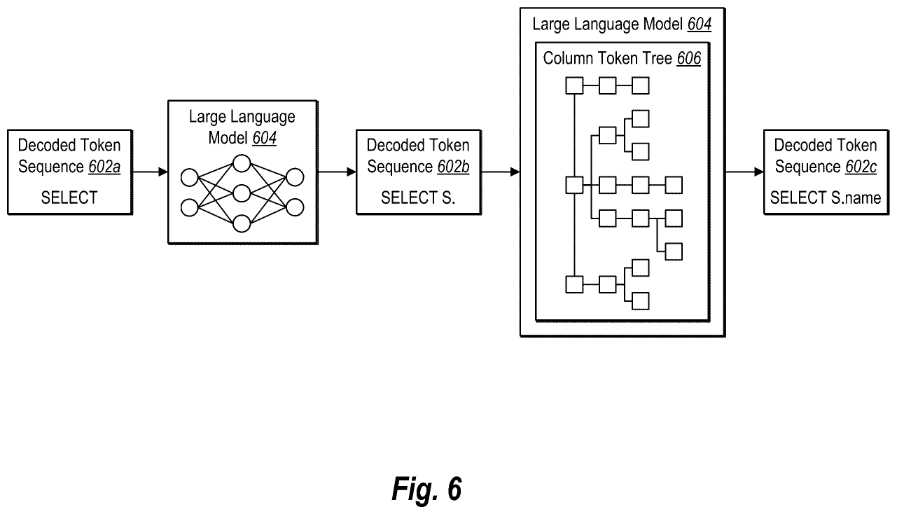

As previously noted, in one or more embodiments, the tree guided decoding system 106 restricts the decoding space of a large language model to the tokens of a token tree representing elements of a database schema. For example, in one or more implementations, the tree guided decoding system 106 restricts the decoding space to tokens representing table names or column names of tables of the database schema. FIG. 6 illustrates a diagram of the tree guided decoding system 106 generating a decoded token sequence by restricting the decoding space of a large language model to a column token tree in accordance with one or more embodiments.

As illustrated in FIG. 6, in some embodiments, the tree guided decoding system 106 utilizes a large language model 604 (e.g., large language model 204) to decode tokens of a decoded token sequence 602b. In some implementations, the tree guided decoding system 106 generates some tokens of the decoded token sequence 602b utilizing the large language model 604 without restricting the decoding space of the large language model 604. To illustrate, the tree guided decoding system 106 decodes next tokens (i.e., “s” and “.”) for the decoded token sequence 602a utilizing the large language model 604 without restricting the decoding space resulting in the decoded token sequence 602b.

As further illustrated in FIG. 6, in some implementations, the tree guided decoding system 106 restricts the decoding space of the large language model 604 to the elements of the database schema. In particular, the tree guided decoding system 106 restricts the decoding space of the large language model to tokens of a column token tree 606 (e.g., column token tree 420). For example, the tree guided decoding system 106 restricts the decoding space based on one or more decoded tokens of the decoded token sequence 602b.

As just mentioned, in one or more embodiments, the tree guided decoding system 106 restricts the decoding space of the large language model 604 based on decoded tokens of the decoded token sequence 602b. Specifically, in one or more implementations, the tree guided decoding system 106 restricts the decoding space to the column token tree 606 by determining that the last decoded token of the decoded token sequence 602b includes “.” and the penultimate decoded token does not include a number. In these or other embodiments, the tree guided decoding system 106 restricts the decoding space of the large language model 604 to the column token tree 606 including tokens representing the column names of table columns of the database schema.

To illustrate, the tree guided decoding system 106 determines that the last decoded token of the decoded token sequence 602b is “.” and the penultimate decoded token of the decoded token sequence 602b is “s”. Based on this determination, the tree guided decoding system 106 restricts the decoding space of the large language model 604 to the tokens of the column token tree 606 when decoding the next token(s) of the decoded token sequence. Indeed, in this example, the tree guided decoding system 106 generates the decoded token sequence 602c with the next decoded token(s) “name.”

As mentioned above, in some embodiments, the tree guided decoding system 106 restricts the decoding space of a large language model to the tokens of a token tree representing elements of a database schema. For instance, in some implementations, the tree guided decoding system 106 restricts the decoding space to tokens representing table names of the database schema. FIG. 7 illustrates a diagram of the tree guided decoding system 106 generating a decoded token sequence by restricting the decoding space of a large language model to a table token tree in accordance with one or more embodiments.

As shown in FIG. 7, in one or more embodiments, the tree guided decoding system 106 utilizes the large language model 704 (e.g., large language model 204) to generate next token(s) for the decoded token sequence 702a. In particular, the tree guided decoding system 106 generates the next token(s), “FROM”, to generate the decoded token sequence 702b. For example, the tree guided decoding system 106 generates the next token(s) either without restricting the decoding space of the large language model 704 or by restricting the decoding space to the tokens of a token tree.

As also depicted in FIG. 7, in one or more implementations, the tree guided decoding system 106 restricts the decoding space of the large language model 704 to tokens of a token tree representing elements of the database schema, as mentioned above. Specifically, the tree guided decoding system 106 restricts the decoding space of the large language model 704 to the tokens of a table token tree 706 (e.g., table token tree 418). For example, the tree guided decoding system 106 restricts the decoding space of the large language model 704 to the table token tree 706 including tokens representing table names of the tables of the database schema.

Moreover, in some embodiments, the tree guided decoding system 106 restricts the decoding space to the tokens included in the table token tree 706 based on one or more decoded tokens of the decoded token sequence 702b. In particular, the tree guided decoding system 106 restricts the decoding space to the tokens of the table token tree 706 by determining that the last decoded token(s) comprise “FROM” or “JOIN.” Furthermore, in some implementations, the tree guided decoding system 106 restricts the decoding space to the tokens of the table token tree 706 in cases where “FROM” or “JOIN” are followed by a parenthesis “(”, e.g., to accommodate for nested queries.

As further illustrated in FIG. 7, in one or more embodiments, the tree guided decoding system 106 generates a next token for the decoded token sequence 702b resulting in the decoded token sequence 702c. For example, the tree guided decoding system 106 utilizes the large language model 704 to decode the next token by determining a most probable next token (e.g., via auto-regressive decoding) from among the tokens of the restricted decoding space. In this example, the tree guided decoding system 106 decodes the next token “singer” as shown in the decoded token sequence 602c.

As additionally shown in FIG. 7, in one or more implementations, the tree guided decoding system 106 generates the next token by traversing the tokens of the token tree according to token edges of the token tree as mentioned above. Specifically, the tree guided decoding system 106 determines a vertex of the table token tree 706 corresponding to the last decoded token(s), “singer” and determines a number of child vertices of the vertex. Additionally, in some embodiments, the tree guided decoding system 106 generates the next tokens based on the number of child vertices of the vertex.

As further illustrated in FIG. 7, in some implementations, the tree guided decoding system 106 generates the next tokens by performing an act 708 of auto-filling (i.e., without calling/invoking the large language model 704) the tokens when the vertex corresponding to the last token(s) includes a single child vertex. To illustrate, the tree guided decoding system 106 determines that the vertex corresponding to “singer” in the table token tree 706 comprises a single child vertex “singer_”. In these or other embodiments, the tree guided decoding system 106 auto-fills the next token in a decoded token sequence 702d with token corresponding to the single child vertex, “singer_.”

Further, in one or more embodiments, the tree guided decoding system 106 traverses the tokens of the table token tree 706 according to the token edges, determining the number of child vertices for each vertex. For example, the tree guided decoding system 106 traverses the child tokens of the “singer” vertex in the table token tree 706, determining a number of child vertices for each subsequent vertex. In this example, because each successive child vertex downstream from the “singer” vertex includes a single child vertex, the tree guided decoding system 106 auto-fills the next tokens in the decoded token sequence 702d to include all of the tokens corresponding to these vertices. To illustrate, the tree guided decoding system 106 generates the next tokens of the decoded token sequence 702d to include “singer_in_concert.”

By auto-filling the next tokens when generating code utilizing tree-guided decoding, the tree guided decoding system 106 reduces both latency and errors in the code generation process as described above. For example, when auto-filling based on a single child vertex, the tree guided decoding system 106 need not utilize the auto-regressive function of the large language model 704 to determine a most probable next token. Moreover, the tree guided decoding system 106 cannot err in generating the next token when auto-filling because the token tree includes the correct next token in the child vertex.

As also depicted in FIG. 7, in some cases, the tree guided decoding system 106 determines that a vertex of the token tree (e.g., the table token tree 706) includes a plurality of child vertices. In these or other embodiments, the tree guided decoding system 106 decodes the next token utilizing the auto-regressive capability of the large language model 704 to determine the most probable next token from among the tokens corresponding to the child vertices.

To illustrate, if the tree guided decoding system 106 determines that the vertex “singer” includes more than a single child vertex, the tree guided decoding system 106 proceeds along the pathway 710. In this example, the tree guided decoding system 106 utilizes the large language model with the decoding space restricted to the table token tree 706 to determine the next token from among the child vertices. In one or more implementations, the tree guided decoding system 106 determines that the next tokens comprise “singer_in_concert” as shown. Alternatively, in some embodiments, the tree guided decoding system 106 determines a different set of next tokens by selecting a child vertex other than “singer_”.

In some implementations, the tree guided decoding system 106 generates code by traversing the tokens of the token trees as just described. In particular, the tree guided decoding system 106 generates code by determining the number of child vertices of a vertex and performing auto-filling or autoregressive decoding based on the number of child vertices. Indeed, in one or more embodiments, the tree guided decoding system 106 generates code in this way for each type of token tree (e.g., a language token tree, a table token tree, or a column token tree).

Furthermore, in one or more implementations, upon completion of the code, the tree guided decoding system 106 the tree guided decoding system 106 causes a computing device to perform the operation on the database. Specifically, the tree guided decoding system 106 generates the code to perform an operation on the database in response to a natural language prompt as described above. Additionally, in these or other embodiments, the tree guided decoding system 106 causes a computing device to utilize the code to perform the operation on the database. In some embodiments, in this manner, the tree guided decoding system 106 generates a response to the natural language prompt and returns, or causes the computing device to return, the response. For example, the tree guided decoding system 106 returns the response, or causes the response to be returned, to a computing device associated with the natural language prompt.

As described in relation to FIGS. 2-7, in some implementations, the tree guided decoding system 106 performs operations for generating code utilizing a large language model by restricting the decoding space of the large language model to tokens of a token tree and generating tokens of the code by traversing the tokens of the token tree. The operations allow tree guided decoding system 106 to more efficiently and accurately generate code for a performing an operation on a database (or perform other highly structured tasks) utilizing one or more large language models. Accordingly, in one or more embodiments, the acts and operations illustrated and described above in relation to FIGS. 2-7 provide the corresponding acts (e.g., structure) for a step for generating the code by restricting a decoding space of the large language model. For instance, the acts and operations provide the corresponding acts for a step for restricting the decoding space of the large language model to elements of a database schema of the database and/or elements of a programming language corresponding to the code.

As noted above, in one or more implementations, the tree guided decoding system 106 improves the efficiency and accuracy of utilizing a large language model to generate code (or perform other highly structured tasks). Indeed, in some embodiments, the tree guided decoding system 106 improves the efficiency and accuracy by generating accurate table trees for elements of a database schema and/or programming language, restricting the token space of the large language model to the tokens of a table tree, and generating tokens by traversing the token tree. Table 1 illustrates execution accuracy, token rates, and executable code (e.g., SQLs) achieved by the tree guided decoding system 106 (TGDS) compared with corresponding metrics achieved by example prior art systems (CS 1 and CS 2) in two different datasets in accordance with one or more embodiments. In table 1, increments and decrements are shown with respect to CS 1.

TABLE 1

| | Dataset 1 | | | Dataset 2 | | |
|---|---|---|---|---|---|---|
| Metric | CS 1 | CS 2 | TGDS | CS 1 | CS 2 | TGDS |
| Execution | 50.9% | 52.2% | 51.7% | 21.2% | 21.2% | 22% |
| Accuracy (EX) | | (↑2.55%) | (↑1.57%) | | | (↑3.77%) |
| Token Rate (TR) | 15.74 | 14.77 | 17.33 | 15.17 | 13.64 | 15.59 |
| | | (↓6.16%) | (↑10.1%) | | (↓10.09%) | (↑2.77%) |
| #Executable SQLs | 744 | 754 | 759 | 255 | 255 | 288 |
| | | (+10) | (+15) | | | (+33) |

Further, in some implementations, the tree guided decoding system 106 restricts the decoding space of large language models to the tokens of a table tree and generates tokens of decoded token sequence (e.g., of code being generated) as described above with respect to FIGS. 2-7 in a plurality of different decoding configurations. In particular, in one or more embodiments, the tree guided decoding system 106 performs these operations in an auto-regressive decoding configuration or in a speculative decoding configuration. For example, in one or more implementations, the tree guided decoding system 106 improves efficiency and accuracy of generating code (or other highly structured tasks) in a speculative decoding setting (with both the draft large language model and the target large language model). Indeed, Table 2 illustrates token rates achieved by the tree guided decoding system 106 (TGDS) implemented with a conventional speculative decoding model compared with the conventional speculative decoding model (CS 3) without the tree guided decoding system 106 implemented.

TABLE 2

| Metric | CS 3 | TGDS |
|---|---|---|
| Token Rate (TR) | 5.29 ± 0.06 | 5.66 ± 0.09 |

Turning to FIG. 8, additional detail will now be provided regarding various components and capabilities of the tree guided decoding system 106. In particular, FIG. 8 illustrates an example schematic diagram of a computing device 800 (e.g., the server device(s) 102 and/or the client device(s) 110) implementing the tree guided decoding system 106 in accordance with one or more embodiments of the present disclosure for components 800-808. As illustrated in FIG. 8, the tree guided decoding system 106 includes a token tree generator 802, a token tree manager 804, an operation manager 806, and a storage manager 808.

The token tree generator 802 generates token trees based on a database schema and/or programming language. Specifically, the token tree generator 802 determines a database schema of a database in response to a natural language prompt to generating code for performing an operation on the database. Moreover, token tree generator 802 generates token trees based on the elements of the database schema and programming language (e.g., of the database). Furthermore, the token tree generator 802 interacts with other components to pass the token trees for further processes.

Additionally, the token tree manager 804 restricts the decoding space of the large language model(s) 114 and generates code based on the token trees. In particular, the token tree manager 804 receives the token trees from the token tree generator. Further, the token tree manager 804 restricts the decoding space of the large language model(s) 114 to tokens of the token trees representing elements of the database schema or the programming language according to the tokenizer of the large language model(s) 114. Moreover, the token tree manager 804 accesses the large language model(s) 114 and restricts the decoding space of the large language model(s) 114 to a token tree.

Furthermore, the token tree manager 804 utilizes the large language model(s) 114 with the restricted decoding space to generate the code. Specifically, the token tree manager 804 generates the code by traversing the tokens of the token tree representing the restricted decoding space. Additionally, the token tree manager 804 traverses the tokens of the token tree according to token edges of the token tree and a decoded token sequence of the code being generated. Further, the token tree manager interacts with other components to pass the code for further processes.

Moreover, the operation manager 806 performs an operation on the database based on the code. In particular, the operation manager 806 receives the code from the token tree manager. Furthermore, the operation manager 806 accesses the database and utilizes the code to perform the operation indicated by the natural language prompt. For example, operation manager 806 utilizes the code to perform the operation and, in some cases, returns a response based on the operation. Specifically, the operation manager 806 returns the response to a client device associated with the natural language prompt.

Additionally, as shown in FIG. 8, the tree guided decoding system 106 includes a storage manager 808. In one or more implementations, the storage manager 808 stores information (e.g., via one or more memory devices) on behalf of the tree guided decoding system 106. For example, the storage manager 808 includes a database for storing tokens generated from the elements, token trees, generated code, etc.

In some embodiments, each of the components 802-808 of the tree guided decoding system 106 include software, hardware, or both. For example, the components 802-808 include one or more instructions stored on a computer-readable storage medium and executable by processors of one or more computing devices, such as a client device or server device. When executed by the one or more processors, the computer-executable instructions of the tree guided decoding system 106 cause the computing device(s) to perform the methods described herein. Alternatively, the components 802-808 include hardware, such as a special-purpose processing device to perform a certain function or group of functions. Alternatively, the components 802-808 of the tree guided decoding system 106 include a combination of computer-executable instructions and hardware.

Furthermore, the components 802-808 of the tree guided decoding system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 802-808 of the tree guided decoding system 106 are implemented as a stand-alone application, such as a desktop or mobile application. Furthermore, in various embodiments, the components 802-808 of the tree guided decoding system 106 are implemented as one or more web-based applications hosted on a remote server. Alternatively, or additionally, the components 802-808 of the tree guided decoding system 106 are implemented in a suite of mobile device applications or “apps.” For example, in one or more embodiments, the tree guided decoding system 106 comprises or operates in connection with digital software applications such as ADOBE® DATA PLATFORM, and/or ADOBE® EXPERIENCE PLATFORM.

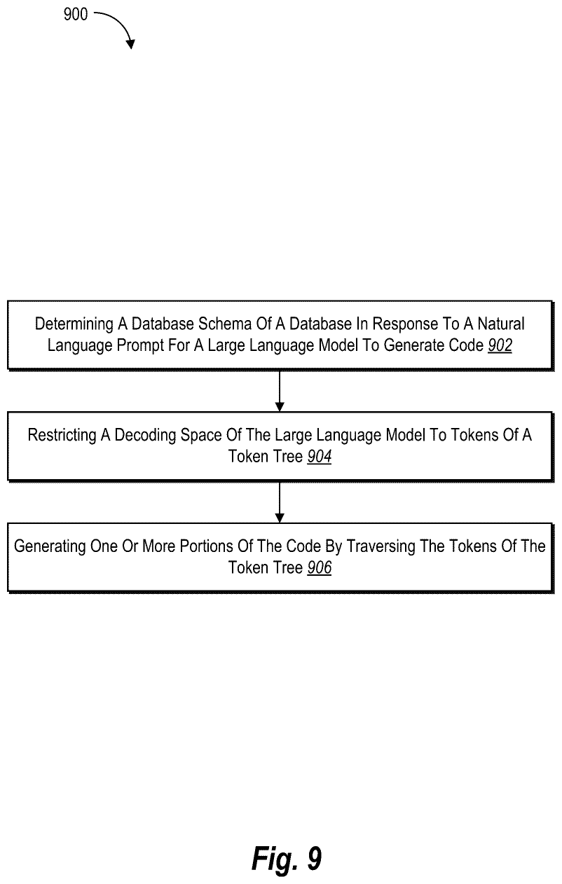

FIGS. 1-8, the corresponding text, and the examples provide a number of different systems, methods, and non-transitory computer readable media for utilizing token tree-based restricted decoding in large language models to generate code for performing an operation on a database. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to some embodiments, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 for utilizing token tree-based restricted decoding in large language models to generate code for performing an operation on a database. The series of acts 900 can include an act 902 of determining a database schema of a database in response to a natural language prompt for a large language model to generate code; an act 904 of restricting a decoding space of the large language model to tokens of a token tree; and an act 906 of generating one or more portions of the code by traversing the tokens of the token tree.

In some embodiments, the act 902 includes determining a database schema of a database in response to a natural language prompt for a large language model to generate code for performing an operation on the database. In some embodiments, the act 904 also includes an act of restricting a decoding space of the large language model to tokens of a token tree representing elements of the database schema according to a tokenizer of the large language model. In some implementations, the series of acts 906 further includes an act of generating, utilizing the large language model, one or more portions of the code by traversing the tokens of the token tree according to token edges of the token tree and a decoded token sequence.

In some implementations, restricting the decoding space of the large language model to the tokens of the token tree representing the elements of the database schema includes restricting the decoding space of the large language model to tokens of a table token tree, the tokens of the table token tree representing table names of one or more tables of the database schema. In one or more embodiments, restricting the decoding space of the large language model to the tokens of the token tree representing the elements of the database schema includes restricting the decoding space of the large language model to tokens of a column token tree, the tokens of the column token tree representing one or more column names of table columns of the database schema.

In one or more implementations, the series of acts 900 includes restricting the decoding space of the large language model to tokens of a language token tree representing keywords of a programming language corresponding to the code according to the tokenizer of the large language model. In some embodiments, generating the one or more portions of the code by traversing the tokens of the token tree according to the token edges of the token tree and the decoded token sequence includes determining that a vertex of the token tree corresponding to a decoded token of the decoded token sequence includes a plurality of child vertices. Additionally, in one or more embodiments, the series of acts 900 includes an act of decoding, utilizing the large language model, a next token of the decoded token sequence from a plurality of tokens corresponding to the plurality of child vertices.

In some implementations, the series of acts 900 includes generating one or more additional portions of the code by determining that a vertex of the token tree corresponding to a decoded token of the decoded token sequence includes a single child vertex. In one or more implementations, the series of acts 900 also includes an act of auto-filling a next token of the decoded token sequence with a token corresponding to the single child vertex.

In one or more embodiments, the series of acts 900 includes generating the token tree by generating a comprehensive list of the elements of the database schema. In some embodiments, the series of acts 900 further includes an act of generating, utilizing the tokenizer of the large language model, the tokens from the elements of the database schema in the comprehensive list. Additionally, in some implementations, the series of acts 900 includes an act of generating vertices of the token tree including the tokens. In one or more embodiments, the series of acts 900 also includes an act of generating the token edges of the token tree to represent a sequence in which the tokens appear in the comprehensive list.

In one or more implementations, the series of acts 900 includes generating a mapping of the token tree to the database for access to generate the one or more portions of the code via the large language model. In some embodiments, restricting the decoding space of the large language model to the tokens of the token tree includes accessing the token tree based on the mapping of the token tree to the database. In one or more implementations, the series of acts 900 further includes an act of restricting the decoding space of the large language model utilizing the token tree for generating a response to the natural language prompt.

In some implementations, the act 902 includes determining a database schema of a database in response to a natural language prompt for a large language model to generate code for performing an operation on the database. Additionally, in some embodiments, the act 904 includes an act of restricting a decoding space of the large language model to tokens of one or more token trees representing at least one of elements of the database schema or keywords of a programming language according to a tokenizer of the large language model. In some implementations, the act 906 also includes an act of generating, utilizing the large language model, one or more portions of the code by traversing the tokens of the one or more token trees according to token edges of the one or more token trees and a decoded token sequence.

In one or more embodiments, the series of acts 900 includes generating a token tree of the one or more token trees representing the keywords of the programming language according to the tokenizer of the large language model by generating, utilizing the tokenizer of the large language model, the tokens representing the keywords from a comprehensive list of the keywords of the programming language. In one or more embodiments, the series of acts 900 further includes an act of generating vertices of the token tree including the tokens. Additionally, in one or more implementations, the series of acts 900 includes an act of generating the token edges of the token tree, the token edges representing a sequence in which the tokens appear in the comprehensive list.

In one or more implementations, the series of acts 900 includes restricting the decoding space of the large language model to tokens of a token tree of the one or more token trees representing the keywords of the programming language by determining that a decoded token of the decoded token sequence is present in the token tree. In some embodiments, the series of acts 900 includes restricting the decoding space of the large language model to tokens of a token tree of the one or more token trees representing the elements of the database schema based on one or more decoded tokens of the decoded token sequence.

In some implementations, the series of acts 900 includes generating the one or more portions of the code by traversing the tokens of the one or more token trees according to the token edges of the one or more token trees and the decoded token sequence by determining a vertex of the one or more token trees corresponding to a decoded token of the decoded token sequence. In some embodiments, the series of acts 900 also includes an act of determining a number of child vertices of the vertex. In some implementations, the series of acts 900 further includes an act of generating the one or more portions of the code based on the number of child vertices of the vertex.

In one or more embodiments, the series of acts 900 includes generating the one or more portions of the code based on the number of child vertices by determining that the number of child vertices of the vertex includes a plurality of child vertices. Additionally, in one or more embodiments, the series of acts 900 includes an act of decoding, utilizing the large language model, a next token of the decoded token sequence from a plurality of tokens corresponding to the plurality of child vertices.

In one or more implementations, the series of acts 900 includes generating one or more additional portions of the code based on a number of child vertices of an additional decoded token of the decoded token sequence by determining an additional vertex of the one or more token trees corresponding to the additional decoded token of the decoded token sequence. In one or more implementations, the series of acts 900 also includes an act of determining that the number of child vertices of the additional vertex includes a single child vertex. In some embodiments, the series of acts 900 further includes an act of auto-filling, without calling the large language model, an additional next token of the decoded token sequence with a token corresponding to the single child vertex.

In some embodiments, the series of acts 900 includes cause a computing device to perform the operation on the database utilizing the one or more portions of the code generated via the large language model and the one or more additional portions of the code including the additional next token. In some implementations, the act 902 includes determining, by at least one processor, a natural language prompt for a large language model to generate code for performing an operation on a database. Additionally, in some implementations, the act 904 includes an act of performing a step for generating the code by restricting a decoding space of the large language model. In one or more embodiments, the series of acts 900 also includes an act of accessing, by the at least one processor, the database to perform the operation on the database utilizing the code generated via the large language model.

In one or more embodiments, performing the step for generating the code via the large language model by restricting the decoding space of the large language model includes performing a step for restricting the decoding space of the large language model to elements of a database schema of the database. In one or more implementations, performing the step for generating the code via the large language model by restricting the decoding space of the large language model includes performing a step for restricting the decoding space of the large language model to elements of a programming language corresponding to the code.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device 800, the client device(s) 110, and/or the server device(s) 102) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

1. A non-transitory computer readable medium storing executable instructions which, when executed by a processing device, cause the processing device to perform operations comprising:
determining a database schema of a database in response to a natural language prompt for a large language model to generate code for performing an operation on the database;
restricting a decoding space of the large language model to tokens of a token tree representing elements of the database schema according to a tokenizer of the large language model; and
generating, utilizing the large language model, one or more portions of the code by traversing the tokens of the token tree according to token edges of the token tree and a decoded token sequence.

2. The non-transitory computer readable medium of claim 1, wherein restricting the decoding space of the large language model to the tokens of the token tree representing the elements of the database schema comprises restricting the decoding space of the large language model to tokens of a table token tree, the tokens of the table token tree representing table names of one or more tables of the database schema.

3. The non-transitory computer readable medium of claim 1, wherein restricting the decoding space of the large language model to the tokens of the token tree representing the elements of the database schema comprises restricting the decoding space of the large language model to tokens of a column token tree, the tokens of the column token tree representing one or more column names of table columns of the database schema.

4. The non-transitory computer readable medium of claim 1, wherein the operations further comprise restricting the decoding space of the large language model to tokens of a language token tree representing keywords of a programming language corresponding to the code according to the tokenizer of the large language model.

5. The non-transitory computer readable medium of claim 1, wherein generating the one or more portions of the code by traversing the tokens of the token tree according to the token edges of the token tree and the decoded token sequence comprises:
determining that a vertex of the token tree corresponding to a decoded token of the decoded token sequence comprises a plurality of child vertices; and
decoding, utilizing the large language model, a next token of the decoded token sequence from a plurality of tokens corresponding to the plurality of child vertices.

6. The non-transitory computer readable medium of claim 1, wherein the operations further comprise generating one or more additional portions of the code by:
determining that a vertex of the token tree corresponding to a decoded token of the decoded token sequence comprises a single child vertex; and
auto-filling a next token of the decoded token sequence with a token corresponding to the single child vertex.

7. The non-transitory computer readable medium of claim 1, wherein the operations further comprise generating the token tree by:
generating a comprehensive list of the elements of the database schema;
generating, utilizing the tokenizer of the large language model, the tokens from the elements of the database schema in the comprehensive list;
generating vertices of the token tree comprising the tokens; and
generating the token edges of the token tree to represent a sequence in which the tokens appear in the comprehensive list.

8. The non-transitory computer readable medium of claim 7, wherein the operations further comprise generating a mapping of the token tree to the database for access to generate the one or more portions of the code via the large language model.

9. The non-transitory computer readable medium of claim 8, wherein restricting the decoding space of the large language model to the tokens of the token tree comprises:
accessing the token tree based on the mapping of the token tree to the database; and
restricting the decoding space of the large language model utilizing the token tree for generating a response to the natural language prompt.

10. A system comprising:
one or more memory devices; and
one or more processors configured to cause the system to:
determine a database schema of a database in response to a natural language prompt for a large language model to generate code for performing an operation on the database;
restrict a decoding space of the large language model to tokens of one or more token trees representing at least one of elements of the database schema or keywords of a programming language according to a tokenizer of the large language model; and
generate, utilizing the large language model, one or more portions of the code by traversing the tokens of the one or more token trees according to token edges of the one or more token trees and a decoded token sequence.

11. The system of claim 10, wherein the one or more processors are further configured to generate a token tree of the one or more token trees representing the keywords of the programming language according to the tokenizer of the large language model by:
generating, utilizing the tokenizer of the large language model, the tokens representing the keywords from a comprehensive list of the keywords of the programming language;
generating vertices of the token tree comprising the tokens; and
generating the token edges of the token tree, the token edges representing a sequence in which the tokens appear in the comprehensive list.

12. The system of claim 10, wherein the one or more processors are further configured to restrict the decoding space of the large language model to tokens of a token tree of the one or more token trees representing the keywords of the programming language by determining that a decoded token of the decoded token sequence is present in the token tree.

13. The system of claim 10, wherein the one or more processors are further configured to restrict the decoding space of the large language model to tokens of a token tree of the one or more token trees representing the elements of the database schema based on one or more decoded tokens of the decoded token sequence.

14. The system of claim 10, wherein the one or more processors are further configured to generate the one or more portions of the code by traversing the tokens of the one or more token trees according to the token edges of the one or more token trees and the decoded token sequence by:
determining a vertex of the one or more token trees corresponding to a decoded token of the decoded token sequence;
determining a number of child vertices of the vertex; and
generating the one or more portions of the code based on the number of child vertices of the vertex.

15. The system of claim 14, wherein the one or more processors are further configured to generate the one or more portions of the code based on the number of child vertices by:
determining that the number of child vertices of the vertex comprises a plurality of child vertices; and
decoding, utilizing the large language model, a next token of the decoded token sequence from a plurality of tokens corresponding to the plurality of child vertices.

16. The system of claim 10, wherein the one or more processors are further configured to generate one or more additional portions of the code based on a number of child vertices of an additional decoded token of the decoded token sequence by:
determining an additional vertex of the one or more token trees corresponding to the additional decoded token of the decoded token sequence;
determining that the number of child vertices of the additional vertex comprises a single child vertex; and
auto-filling, without calling the large language model, an additional next token of the decoded token sequence with a token corresponding to the single child vertex.

17. The system of claim 16, wherein the one or more processors are further configured to cause a computing device to perform the operation on the database utilizing the one or more portions of the code generated via the large language model and the one or more additional portions of the code comprising the additional next token.

18. A computer-implemented method comprising:
determining, by at least one processor, a natural language prompt for a large language model to generate code for performing an operation on a database;
performing a step for generating the code by restricting a decoding space of the large language model; and
accessing, by the at least one processor, the database to perform the operation on the database utilizing the code generated via the large language model.

19. The computer-implemented method of claim 18, wherein performing the step for generating the code via the large language model by restricting the decoding space of the large language model comprises performing a step for restricting the decoding space of the large language model to elements of a database schema of the database.

20. The computer-implemented method of claim 18, wherein performing the step for generating the code via the large language model by restricting the decoding space of the large language model comprises performing a step for restricting the decoding space of the large language model to elements of a programming language corresponding to the code.
